(19) United States
(12) Patent Application Publication
(10) Pub. No.: US 2015/0330512 A1
(43) Pub. Date: Nov. 19, 2015

(54) MECHANICAL SEALS

(71) Applicant: AES ENGINEERING LTD., Rotherham, OT (GB)

(72) Inventor: Richard Jonathan Smith, Rotherham (GB)

(73) Assignee: AES ENGINEERING LTD., Rotherham, OT (GB)

(21) Appl. No.: 14/651,266

(22) PCT Filed: Dec. 11, 2013
(86) PCT No.: PCT/GB2013/000543

§ 371 Date: Jun. 11, 2015

(30) Foreign Application Priority Data
Dec. 11, 2012 (GB) GB1222233.7
Jul. 31, 2013 (GB) GB1313724.5

(51) Int. Cl. F16J 15/34; G01K 11/12

(52) U.S. Cl. CPC F16J 15/3492; G01K 11/12

(57) ABSTRACT

A mechanical seal has, at least a portion of, its outmost stationary components provided with a device for indicating the presence or change of the fluid composition, the temperature, or both, of the mechanical seal.

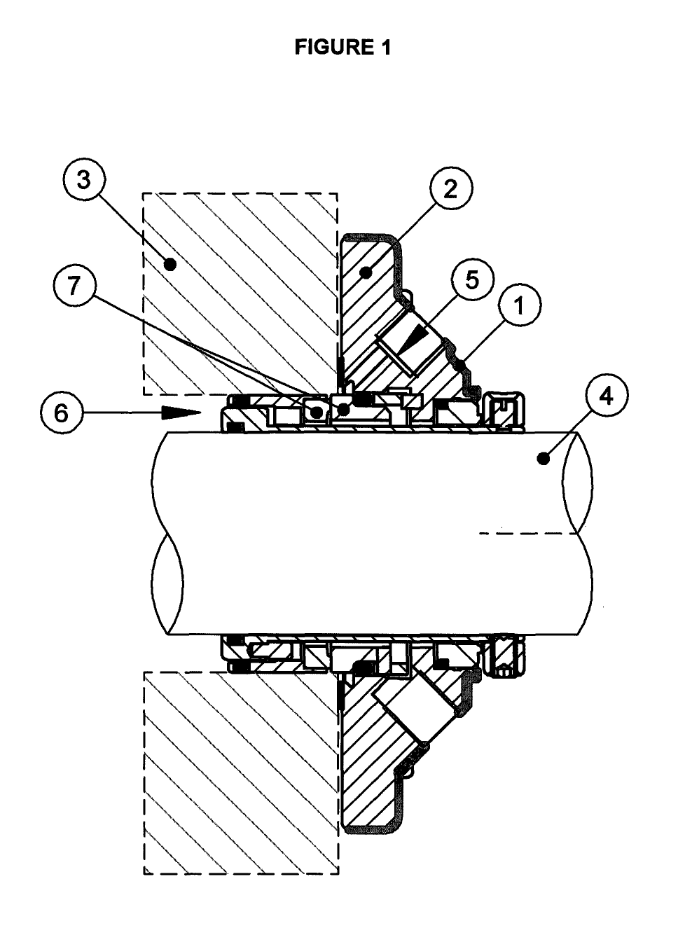

### FIELD OF THE INVENTION

The present invention relates to mechanical seals and to methods of detecting either or both chemical and temperature changes occurring in connection with mechanical seals.

### BACKGROUND TO THE INVENTION

A mechanical seal comprises a rotating member attached to a pump shaft and a stationary member attached to a pump housing. The rotating member is in close contact with the stationary member, providing the seal.

Both the rotating member and the stationary member are commonly referred to in the mechanical sealing industry as ‘seal faces’. A basic operating principle of mechanical seals is that the seal faces require a ‘fluid film’ providing a lubricant between them in order to function correctly.

This fluid film is either the product itself, a ‘barrier’ fluid injected into the seal or often a combination of the two.

If leakage occurs through the seal faces, it would not normally be immediately detectable by an onlooker, nor would the leakage be identifiable as a harmless ‘barrier’ fluid or a potentially harmful process fluid.

### STATEMENTS OF THE INVENTION

The present invention comprises a mechanical seal wherein any or all of the outermost stationary components comprise means for indicating the presence or change of fluid composition and/or the temperature of the mechanical seal.

Preferably, the indicating means comprises a paint or a coating, and more preferably, the colour of the paint or coating changes in response to changes in the pH or temperature. The use of a colour change allows for an easily viewed indication of a change in a parameter.

Preferably, the paint or coating is applied to all outer surfaces of the seal. One or more layers of paint or coating may be applied. More preferably the paint or coating is used as a top coat. Additionally, a plurality of coats may be applied in a particular pattern such that one layer of paint changes colour in a particular manner in response to a change of temperature and a different layer may change to a could in response to a change in acidity.

Preferably, the paint or coating can detect both temperature and acidity. The paint may change colour in response to one or both of temperature and/or acidity.

Preferably, the coating can detect contact with gas in addition to liquid contact.

The paint may comprise a lead-free, all-organic, acrylic modified, alkyd enamel.

The invention is applicable, but is not limited to, single and multiple face seals.

The present invention also provides a method of detecting the presence or change of fluid composition and/or the temperature of a mechanical seal, the method comprising applying to a visually exposed part of the seal means for indicating the presence or change of fluid compositions and/or temperature.

Accordingly, the present invention includes the application of a chemical coating to the visually exposed parts of the seal that may come in contact with the process medium; this coating indicates either or both the fluid leaking and temperature change.

For example, the coating may be applied to the mechanical seal ‘gland’ as it is the most outwardly visible component to any onlooker when installed in situ on the pump.

### DESCRIPTION OF THE DRAWING

The accompanying drawing shows a cross sectional view of a mechanical seal in accordance with the invention where the chemical coating is applied.

### DETAILED DESCRIPTION OF THE DRAWING

The accompanying drawing shows a cross sectional view of a mechanical seal and where a chemical coating 1 is applied. The seal comprises: the chemical coating 1, the stationary gland 2, the pump housing 3, the shaft 4, the barrier fluid direction 5, the process fluid direction 6 and the seal faces 7.

The coating 1 is identified by a thick line in contact with the stationary gland 2.

The stationary gland 2 will vary in overall design but will consistently have all visible outer surfaces coated.

The pump housing 3 is unaffected by the process but supports the mounting of the seal through connection with the stationary gland 2.

The faces 7 are the primary sealing components; they are lubricated through the barrier fluid 5 or the process fluid 6.

1-8. (canceled)

9. A mechanical seal, comprising:
an outermost stationary component including means for indicating at least one of presence and change of at least one of fluid composition and temperature of said mechanical seal.

10. The mechanical seal according to claim 9, wherein said means for indicating comprises a coating.

11. The mechanical seal according to claim 10, wherein said coating is a paint.

12. The mechanical seal according to claim 11, wherein said means for indicating at least one of the presence and the change of one of the fluid composition and the temperature is a color change of the paint.

13. The mechanical seal according to claim 10, wherein said coating is capable of detecting at least one of temperature of said mechanical seal and acidity of the fluid composition.

14. The mechanical seal according to claim 10, wherein said coating is capable of detecting leakage of both gaseous and liquid media.

15. A method for detecting a presence or change of at least one of fluid composition and temperature of a mechanical seal, comprising the step of:
applying means for indicating presence of change of at least one of fluid composition and temperature to a visually exposed part of a mechanical seal.
